(19) United States
(12) Patent Application Publication
(10) Pub. No.: US 2020/0168178 A1
(43) Pub. Date: May 28, 2020

(54) DISPLAY METHOD AND DISPLAY DEVICE

(71) Applicant: SEIKO EPSON CORPORATION, Tokyo (JP)

(72) Inventor: Yusuke YAMADA, Shiojiri-shi (JP)

(73) Assignee: SEIKO EPSON CORPORATION, Tokyo (JP)

(21) Appl. No.: 16/693,635

(22) Filed: Nov. 25, 2019

(30) Foreign Application Priority Data
Nov. 26, 2018 (JP) 2018-219987

(51) Int. Cl. G09G 5/14

(52) U.S. Cl. CPC G09G 5/14

(57) ABSTRACT

A display method of including an image (a thumbnail image) to be displayed so as to be disposed on a first virtual axis, rotated around a respective second virtual axis crossing the first virtual axis, and further rotated around the first virtual axis in either of a first display image and a second display image, and displaying the first display image and the second display image on a first screen and a second screen includes the step of disposing a boundary between the first screen (a first display screen) and the second screen (a second display screen) between the first display image and the second display image adjacent to each other.

The present application is based on, and claims priority from JP Application Serial Number 2018-219987, filed Nov. 26, 2018, the disclosure of which is hereby incorporated by reference herein in its entirety.

### BACKGROUND

### 1. Technical Field

The present disclosure relates to a display method and a display device.

### 2. Related Art

In the past, there has been disclosed a display method of displaying a plurality of folders and a plurality of images folded therein. As such a display method, JP-A-2017-142711 (Document 1), for example, describes a configuration in which a page image display area and a thumbnail image display area sectioned by an imaginary line A are provided in one display image, and a main image is displayed on the page image display area, while a search image such as a thumbnail bundle is displayed in the thumbnail image display area.

However, the display method described in Document 1 does not have a display configuration of using two display screen, but displays two images different from each other in the respective image display areas configured by sectioning the one display screen with the imaginary line A. When two images have been displayed in such a display configuration, there is a possibility that the images, namely the main image and the search image such as the thumbnail bundle, overlap each other in the boundary between the two image display areas, and when the two images have overlap each other, it becomes difficult to view each of the images.

### SUMMARY

A display method according to an aspect of the present disclosure is a display method of including an image to be displayed so as to be disposed on a first virtual axis, rotated around a respective second virtual axis crossing the first virtual axis, and further rotated around the first virtual axis in either of a first display image and a second display image, and displaying the first display image and the second display image on a first screen and a second screen, the method including the step of disposing a boundary between the first screen and the second screen between the first display image and the second display image adjacent to each other.

In the display method described above, the first display image and the second display image may be displayed except a part running off one of the first screen and the second screen where the first display image and the second display image are displayed.

In the display method described above, the first display image may include an image bundle having a plurality of the images arranged in a first direction, and the second display image may include a main image obtained by expanding a page corresponding to an image selected from the plurality of images.

In the display method described above, the second display image may include a reference image in addition to the main image, and the reference image may be determined by selecting another image from the image bundle.

In the display method described above, the image selected may be displayed in a double-page spread state.

In the display method described above, the image selected may be displayed so as to increase in distance from an adjacent image to prevent superimposition with the adjacent image.

In the display method described above, a plurality of the image bundles may be displayed so as to be arranged in a second direction crossing the first direction.

A display device according to an aspect of the present disclosure includes a first screen and a second screen on which either of a first display image and a second display image is displayed, an image generation section configured to generate an image displayed so as to be disposed on a first virtual axis, rotated around a second virtual axis crossing the first virtual axis, and further rotated around the first virtual axis, a display image generation section configured to generate the first display image and the second display image so that the image is included in either of the first display image and the second display image, and a control section configured to display the first display image and the second display image on the first screen and the second screen so that a boundary between the first screen and the second screen is disposed between the first display image and the second display image adjacent to each other.

### BRIEF DESCRIPTION OF THE DRAWINGS

FIG. 1 is an external perspective view showing an outline of a portable terminal device as an example of a display device according to a first embodiment.

FIG. 2 is a block diagram showing a hardware configuration of the display device.

FIG. 3 is a diagram showing Display Example 1 of the thumbnail bundle including the thumbnail images, and a main page.

FIG. 4A is a diagram for explaining a process of deforming the thumbnail image.

FIG. 4B is a diagram for explaining the process of deforming the thumbnail image.

FIG. 4C is a diagram for explaining the process of deforming the thumbnail image.

FIG. 4D is a diagram for explaining the process of deforming the thumbnail image.

FIG. 4E is a diagram for explaining the process of deforming the thumbnail image.

FIG. 5 is a diagram showing Display Example 2 to be displayed on the display device according to the first embodiment.

FIG. 6 is a diagram showing Display Example 3 of a thumbnail bundle including the thumbnail images and a main page to be displayed on a display device according to a second embodiment.

FIG. 7 is a diagram showing Display Example 4 to be displayed on the display device according to the second embodiment.

FIG. 8 is a diagram showing a modified example.

### DESCRIPTION OF EXEMPLARY EMBODIMENTS

Some embodiments of a display device and a display method on the display device will hereinafter be described with reference to the drawings. It should be noted that the embodiments described below do not unreasonably limit the contents of the present disclosure as set forth in the appended claims. Further, all of the constituents described in the following embodiments are not necessarily essential elements of the present disclosure.

### 1. First Embodiment

### 1.1. Display Device

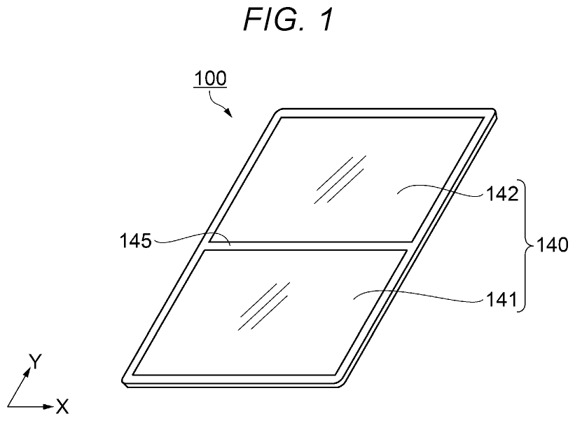

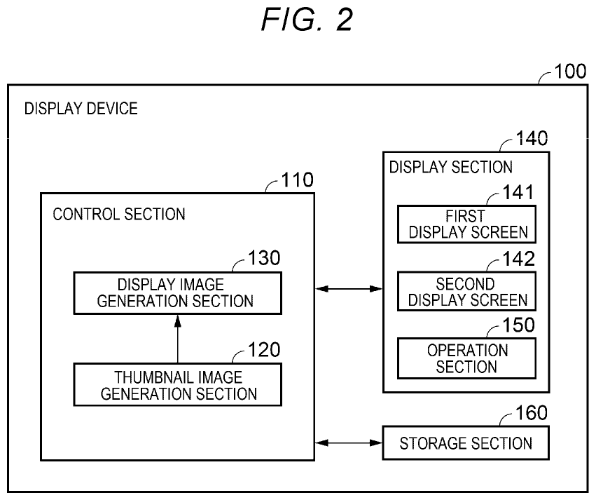

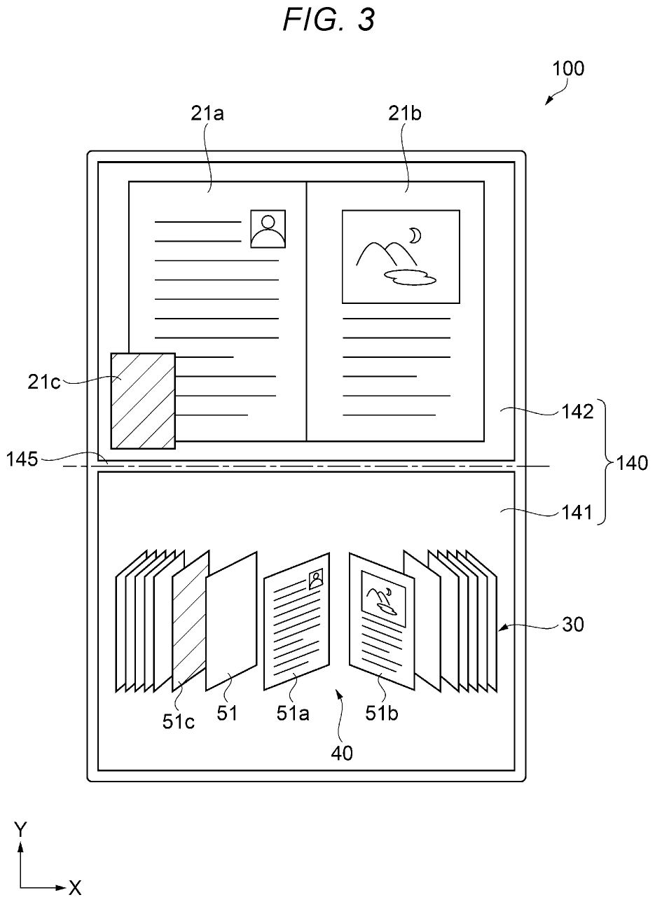

Firstly, a configuration of the display device according to the first embodiment will be described with reference to FIG. 1, FIG. 2, and FIG. 3. FIG. 1 is an external perspective view showing an outline of a portable terminal device as an example of the display device according to the first embodiment. FIG. 2 is a block diagram showing a hardware configuration of the display device. It should be noted that FIG. 2 is a block diagram showing a configuration of a function related to display of each page of electronic book or electrophotography, thumbnail images, and a thumbnail bundle in the display device. FIG. 3 is a diagram showing Display Example 1 of the thumbnail bundle including the thumbnail images, and a main page.

As shown in FIG. 1, the display device 100 according to the first embodiment is a device for viewing an electronic book, electrophotography, and so on, and displays thumbnail images as images obtained by contracting the pages of the electronic book or the electrophotography as search images of the images of the pages of the electronic book or the electrophotography folded in a file of a folder and a screen desired to be displayed. In other words, the display device 100 is an example of an electronic apparatus capable of displaying an image. It should be noted that the description will hereinafter be presented illustrating, as images to be displayed on the display device 100, a plurality of thumbnail images 51, 51a, and 51b, and so on (see FIG. 3), and a thumbnail bundle 30 (see FIG. 3) as an image bundle for displaying the thumbnail images 51, 51a, and 51b, and so on in an arranged manner. Further, in the present embodiment, the description will be presented using a “file” as a collective term of a folder and a file.

Further, although in the following description, a “first direction” and a “second direction” are used, the “first direction” in the present application corresponds to a horizontal direction (a lateral direction) when making a screen constituting a display section 140 be correctly opposed to a user in the state in which display on the display section 140 is legible. Further, the “second direction” is a direction crossing the first direction, and corresponds to a vertical direction (a longitudinal direction) when making the screen constituting the display section 140 be correctly opposed to the user in the state in which the display on the display section 140 is legible. Further, in each of the drawings used for the explanation of the display device 100 and the display section 140, two axes perpendicular to each other are set as an X axis and a Y axis for the sake of convenience of explanation. In other words, the X axis coincides with the “first direction” as a direction along a horizontal direction (a lateral direction) of the display section 140, and the Y axis coincides with the “second direction” as a direction along a vertical direction (a longitudinal direction) of the display section 140. Further, for the sake of convenience of explanation, a positive direction of the Y axis is referred to as “up” or an “upper side,” a negative direction of the Y axis is referred to as “down” or a “lower side,” a positive direction of the X axis is referred to as “right” or a “right side,” and a negative direction of the X axis is referred to as “left” or a “left side” in some cases.

The display device 100 can be constituted by, for example, a smartphone or a tablet-type terminal device. The display device 100 can be coupled to other information processing devices (not shown) with, for example, Near Field Communication or wired communication (not shown), wherein Bluetooth (registered trademark), for example, can be cited as an example of Near Field Communication.

As shown in FIG. 1, the display device 100 according to the first embodiment is provided with the display section 140 having a first display screen 141 and a second display screen 142 as two screens for displaying images. It should be noted that the first display screen 141 corresponds to a first screen, and the second display screen 142 corresponds to a second screen. The first display screen 141 and the second display screen 142 are arranged side by side along the Y axis via a boundary 145 constituted by a frame part of the first display screen 141 or the second display screen 142. It should be noted that the display device 100 according to the present embodiment illustrates a folding portable terminal device which can be folded at the boundary 145 part. It is possible for the user to visually recognize an image displayed on the display section 140 having the first display screen 141 and the second display screen 142 formed of a liquid crystal display or the like of the display device 100. It should be noted that it is possible for the display device 100 to use respective screens of two tablet type terminal devices formed as separate individuals, or to use respective screens of two smartphones as another configuration having two screens. Further, it is possible for the display device 100 to combine, for example, the tablet type terminal device and the smartphone with each other to constitute the display section 140. Further, the boundary 145 can be formed of a boundary line (not shown) for sectioning one screen into two on the screen instead of the frame part.

As shown in FIG. 2, the display device 100 is provided with a control section 110 including a thumbnail image generation section 120 and a display image generation section 130, the display section 140 including an operation section 150, and a storage section 160 as a hardware configuration.

The control section 110 includes the thumbnail image generation section 120 and the display image generation section 130. The control section 110 is a microcomputer provided with a central processing unit (CPU), a read only memory (ROM), a random access memory (RAM), and so on, and controls each section of the display device 100 in accordance with a program stored in the ROM. The control section 110 identifies an operation content from a signal transmitted from the operation section 150 to perform a process of turning the page of an electronic book forward, a process of turning the page backward, a process of displaying a display image such as a thumbnail image or a thumbnail bundle on the display section 140 in accordance with the content thus identified.

Specifically, it is possible for the control section 110 to access the storage section 160 to thereby writing or retrieving a variety of types of data such as an electronic book or electrophotography into or from the storage section 160. Further, it is possible for the control section 110 to make the thumbnail image generation section 120 and the display image generation section 130 generate the thumbnail image or an image of the thumbnail bundle obtained by contracting a variety of types of data related to each pages of the electronic book or the electrophotography or a variety of types of data such as the electronic book or the electrophotography, and generate display image data of these images.

Further, as shown in FIG. 3, the control section 110 displays the image of the thumbnail bundle 30 as an image bundle generated as a first display image in the display image generation section 130 on the first display screen 141 as one screen, and displays main images 21a, 21b generated as a second display image on the second display screen 142 as the other screen. In other words, the control section 110 configures the display image so that the boundary 145 between the first display screen 141 and the second display screen 142 is disposed between the thumbnail bundle 30 as the first display image and the main images 21a, 21b as the second display image adjacent to each other, and then displays the display image on the display section 140. Thus, it is possible to prevent superimposed display between the thumbnail bundle 30 as the first display image and the main images 21a, 21b as the second display image, and thus it is possible to prevent viewing of the images from becoming difficult, namely to prevent each of the images from becoming difficult to view when the two images has been superimposed with each other.

Here, the thumbnail bundle 30 as the first display image is an image bundle in which the plurality of thumbnail images 51 as an image is arranged in the first direction to be displayed. It should be noted that in the present embodiment, in the thumbnail bundle 30, the thumbnail images 51 representatively displays the plurality of thumbnail images corresponding to a plurality of pages included in one file. Further, the main images 21a, 21b to be displayed on the second display screen 142 are not limited to the image corresponding to the two pages, but can also be images corresponding to any number of pages.

The control section 110 constitutes the thumbnail bundle 30 having a constituent part in which the thumbnail images 51 adjacent to each other are arranged at regular intervals in a partially superimposed state, and a constituent part in which the thumbnail images 51 adjacent to each other are arranged so that the distance therebetween increases, or a part where the display direction is different is included using the display image generation section 130. Further, it is possible for the control section 110 to change the intervals between the images adjacent to each other of the thumbnail bundle 30, or to change the direction of the image in accordance with an instruction from the user. In the present display example, selected pages selected from the plurality of thumbnail images 51 included in the thumbnail bundle 30, namely the thumbnail images 51a, 51b corresponding to the pages displayed on the second display screen 142 as the main images 21a, 21b are displayed by the control section 110 as the display 40 in the double-page spread state.

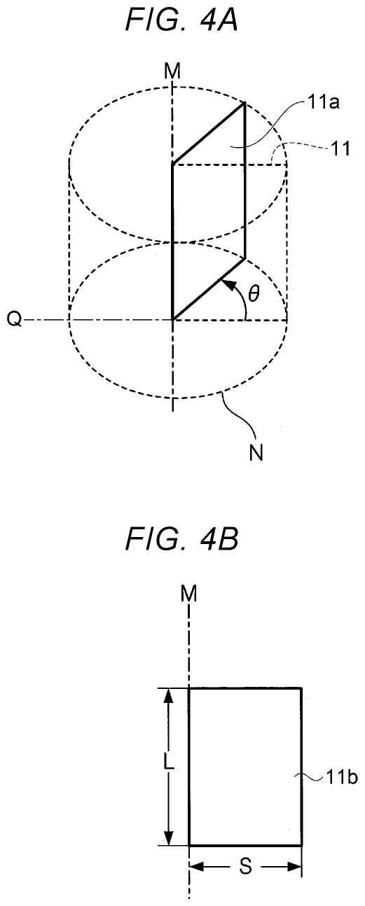

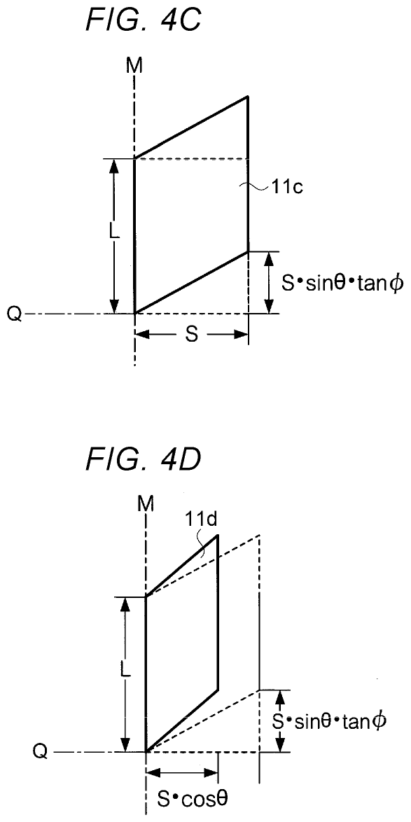

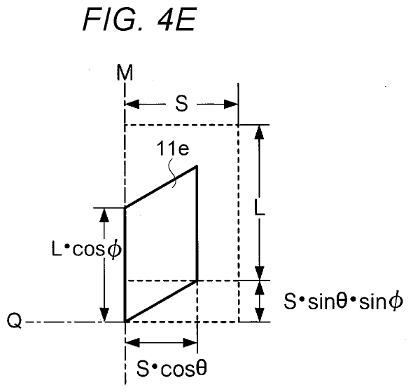

The thumbnail image generation section 120 retrieves a variety of types of data from the storage section 160 to generate the thumbnail images obtained by contracting the variety of types of data such as the electronic book or the electrophotography, for example, the thumbnail images 51. Specifically, the thumbnail image generation section 120 generates the thumbnail images 51 shown in FIG. 3 as a plurality of images which are disposed on a first virtual axis along the first direction as a horizontal direction of the screen constituting, for example, the display section 140, rotated around respective second virtual axes crossing the first virtual axis and along the second direction as the vertical direction of the screen of the display section 140, and further rotated with respect to the first virtual axis. It should be noted that the generation method of the thumbnail images 51 will be described in detail with reference to FIG. 4A through FIG. 4E in the posterior stage.

As shown in FIG. 3, the display image generation section 130 generates the image of the thumbnail bundle 30 having the thumbnail images 51 of the plurality of pages generated by the thumbnail image generation section 120 arranged side by side in the first direction (the X axis) as the horizontal direction of the display section 140. In other words, the display image generation section 130 provides one thumbnail bundle, for example, the thumbnail bundle 30, with a configuration which includes the thumbnail images 51, 51a, 51b of the pages included in one file, and can be looked down. Further, the display image generation section 130 generates the main images 21a, 21b to be displayed on the second display screen 142 as the images of the pages which are selected by the user and thus open, for example, the second display image.

The display section 140 has the first display screen 141 and the second display screen 142 as the two display screens via the boundary 145, and displays the images on the respective display screens. The display section 140 displays the thumbnail bundle 30 including the plurality of thumbnail images 51, 51a, 51b, the main images 21a, 21b obtained by displaying the selected pages selected from the plurality of thumbnail images 51 included in the thumbnail bundle 30 in an enlarged manner, and the like on either of the first display screen 141 and the second display screen 142 as the display image based on the instruction of the control section 110. It is possible for the display section 140 to be formed of a touch panel obtained by combining, for example, a liquid crystal display and a position input device such as a touch pad with each other. It should be noted that it is possible for the display section 140 to make the touch panel function as the operation section 150.

The operation section 150 is formed of a touch panel constituting the first display screen 141 and the second display screen 142. It is possible for the operation section 150 to transmit an operation signal which is generated by an operation of making a finger or the like of the user have contact with the touch panel to perform drag and drop, flick, or the like to the control section 110. It should be noted that it is also possible to constitute the operation section 150 by an operation button (not shown) which is operated by the user holding down the operation button.

The storage section 160 is a memory for storing book data, electrophotography data, and so on as image data to be displayed on the display section 140. It should be noted that a file folding a plurality of pages related to, for example, a plurality of book data as an entity, a file folding a plurality of electrophotographic data as an entity, and so on can be stored in the storage section 160 as a file.

According to the display device 100 related to the present embodiment, there are provided the first display screen 141 as the first screen and the second display screen 142 as the second screen for displaying images on the display section 140, and the boundary 145 between the first display screen 141 and the second display screen 142 is disposed between the thumbnail bundle 30 as the first display image and the main images 21a, 21b as the second display image adjacent to each other. Therefore, it is possible to display the thumbnail bundle 30 and the main images 21a, 21b respectively on the first display screen 141 and the second display screen 142 sectioned from each other, namely the thumbnail bundle 30 is displayed on the first display screen 141 while the main images 21a, 21b are displayed on the second display screen 142, for example. Thus, in the display device 100, it is possible to prevent so-called superimposed display that the thumbnail bundle 30 and the main images 21a, 21b are displayed so as to be superimposed with each other, and thus it is possible to prevent viewing of the images from becoming difficult, namely to prevent each of the images from becoming difficult to view when the two images has been superimposed with each other.

Further, in the display device 100, the thumbnail bundle 30 having the plurality of images arranged in the first direction is displayed as the first display image on the first display screen 141 as one screen, and the main images 21a, 21b each obtained by enlarging the page corresponding to the image selected from the plurality of thumbnail images 51 constituting the thumbnail bundle 30 are displayed as the second display image on the second display screen 142 as the other screen. Therefore, it is possible to make it easier to make out the content of the whole of the thumbnail bundle 30 and the content of the main images 21a, 21b as an images to be focused on using the two screens, namely the first display screen 141 and the second display screen 142.

It should be noted that the thumbnail images 51a, 51b corresponding to the main images 21a, 21b, and displayed on the first display screen 141 are displayed by the control section 110 as the display 40 in the double-page spread state. Due to such display 40 in the double-page spread state, it is possible to make it easy to visually recognize the thumbnail images 51a, 51b corresponding to the main images 21a, 21b in the thumbnail bundle 30, and at the same time, it is possible to make it easy to visually recognize the display contents of the thumbnail images 51a, 51b corresponding to the main images 21a, 21b in the thumbnail bundle 30 and other images in the vicinity of the thumbnail images 51a, 51b.

### 1.2. Display Method 1

### 1.2.1. Display Example 1

Then, Display Example 1 for performing display using Display Method 1 in the display device 100 will be described with reference to FIG. 4A through FIG. 4E in addition to FIG. 3. FIG. 4A through FIG. 4E are diagrams for explaining a process of deforming the thumbnail image. It should be noted that constituent regions in the display device 100 will be described denoted by the same reference symbols as in the above description.

In Display Method 1, as shown in FIG. 3, the thumbnail bundle 30 in which the thumbnail images 51 of the respective pages included in the selected file are arranged in the first direction is displayed as the first display image on the first display screen 141 constituting the display section 140. It should be noted that in the thumbnail bundle 30, the thumbnail images 51a, 51b corresponding to the selected pages selected by the user to focus thereon out of the plurality of thumbnail images 51 included in the thumbnail bundle 30 are displayed as the display 40 in the double-page spread state.

Further, in Display Method 1, the main images 21a, 21b as the second display image are displayed on the second display screen 142 constituting the display section 140. Here, the main images 21a, 21b are images displaying, in an enlarged manner, the pages of the thumbnail images 51a, 51b corresponding to the selected pages selected by the user from the plurality of thumbnail images 51 included in the thumbnail bundle 30. In other words, the main images 21a, 21b are enlarged images of the pages which the user wants to focus on out of the pages included in the selected file.

In other words, in Display Method 1, the boundary 145 between the first display screen 141 and the second display screen 142 is disposed between the thumbnail bundle 30 as the first display image and the main images 21a, 21b as the second display image adjacent to each other.

The thumbnail bundle 30 has the constituent part in which the thumbnail images 51 adjacent to each other are arranged at regular intervals in a partially superimposed state, and the constituent part in which the thumbnail images 51 adjacent to each other are arranged so that the distance therebetween increases, or a part where the display direction is different is included. Here, the thumbnail images 51 as the images are disposed on the first virtual axis along the first direction (the X axis) of the screen constituting, for example, the display section 140, rotated around the respective second virtual axes crossing the first virtual axis and along the second direction of the screen constituting the display section 140, and further rotated around the first virtual axis. As described above, when the thumbnail images 51 are rotated around the first virtual axis and the second virtual axis, and thus the screen is made to be correctly opposed to the user in the state in which the display is legible, the thumbnail images 51 are deformed into the state in which the thumbnail bundle 30 constituted by the plurality of thumbnail images 51 can be looked down. In other words, the thumbnail images 51 of the respective pages are deformed so that there is obtained substantially the same appearance of the pages as when obliquely viewing the plurality of thumbnail images 51 included in the thumbnail bundle 30 from obliquely above, and looking down the plurality of thumbnail images 51.

Here, the process of deforming the thumbnail image will be described with reference to FIG. 4A, FIG. 4B, FIG. 4C, FIG. 4D, and FIG. 4E. It should be noted that hereinafter in the description related to the process of deforming the thumbnail image, the reference symbols (51, 51a, 51b) of the thumbnail images attached in the above description are omitted.

Each of the thumbnail images supplied from the thumbnail image generation section 120 is an image of the plan view of each of the pages of the book, the electrophotography, or the like, and is an image 11b defining the length in the longitudinal direction as L and the length in the lateral direction as S as shown in FIG. 4B. In other words, the image 11b is configured so that the sides in the longitudinal direction are parallel to the longitudinal direction along the second direction of the display section 140, and the sides in the lateral direction are parallel to the lateral direction along the first direction of the display section 140.

The thumbnail image generation section 120 generates an image obtained by deforming each of the thumbnail images representing the respective pages of the book, the electrophotography, or the like. Specifically, regarding each of the pages, the thumbnail image generation section 120 disposes the page 11a so as to erect on a first virtual axis Q set in a virtual horizontal plane N in a virtual space, and then rotates the page 11a around a respective second virtual axis M crossing the first virtual axis Q so that the lateral direction of the page 11a has a rotational angle θ with respect to a reference position 11 parallel to the lateral direction of the display section 140 as shown in FIG. 4A. Further, the thumbnail image generation section 120 generates an image obtained by rotating the page 11a having been rotated around the respective second virtual axis M in the virtual space around the first virtual axis Q with a depression angle ϕ (not shown). In other words, the thumbnail image generation section 120 generates an image obtained by obliquely looking down the page 11a with the depression angle ϕ (not shown) from a viewpoint above the upper side of the page 11a having been rotated around the second virtual axis M in the virtual space. In other words, the image obtained by deforming each of the thumbnail images is generated as an image of obliquely viewing the page 11a with the depression angle ϕ (not shown) from the viewpoint above the upper side of the page 11a in the virtual space to thereby look down the page 11a. It should be noted that when the page has not been rotated, there is created the state in which the lateral direction of the page is parallel to the lateral direction (the first direction) of the display section 140, and the rotational angle θ is 0°. Further, the depression angle ϕ is set to a predetermined angle. Further, the configuration in which the second virtual axis M is parallel to the side in the longitudinal direction (the second direction) of the page is not a limitation, but it is also possible to adopt a configuration in which the second virtual axis M crosses the side in the lateral direction of the page.

Specifically, before all, the thumbnail image generation section 120 applies a longitudinal deformation to the image 11b (see FIG. 4B) of each of the pages viewed from the front while preventing the lateral width from changing as shown in FIG. 4C to generate an image 11c obtained by shifting the right side of the image 11b shown in FIG. 4B as much as S·sin θ·tan ϕ with respect to the left side. Then, as shown in FIG. 4D, the thumbnail image generation section 120 generates an image 11d obtained by contracting the image 11c shown in FIG. 4C in the lateral direction with a magnification of cos θ. As a result, the lateral width of the image 11d becomes S·cos θ. Then, as lastly shown in FIG. 4E, the thumbnail image generation section 120 generates an image 11e obtained by contracting the image 11d shown in FIG. 4D in the longitudinal direction with a magnification of cos ϕ. As a result, the dimension in the longitudinal direction of the image 11e becomes L·cos ϕ. Thus, it is possible to obtain the image 11e obtained by rotating the page around the second virtual axis M with the rotational angle θ, and further rotating the page around the first virtual axis Q. In other words, there can be obtained the image 11e when rotating the page around the second virtual axis M with the rotational angle θ, and looking down the page from the viewpoint above the upper side of the page with the depression angle ϕ.

It should be noted that the rotational angle θ is set to a predetermined rotational angle θ1 with respect to the selected page identified by the selected page data, or is set to a predetermined rotational angle −θ1 with respect to the previous page of the selected page. Further, with respect to a page other than the selected page, the rotational angle θ is set to a gradually increasing angle as the page number gets away from the selected page, the rotational angle θ of a posterior page of the selected page is set in a range of θ1<θ<90° in the present embodiment, and the rotational angle θ of an anterior page of the selected page is set in a range of −θ1>−θ>−90° in the present embodiment.

In Display Method 1, the control section 110 displays the thumbnail bundle 30 as the first display image on the first display screen 141. Further, the control section 110 displays the main images 21a, 21b as the second display image on the second display screen 142. In other words, in Display Method 1, the boundary 145 between the first display screen 141 and the second display screen 142 constituting the display section 140 is disposed between the thumbnail bundle 30 as the first display image and the main images 21a, 21b as the second display image adjacent to each other, the thumbnail bundle 30 is displayed on the first display screen 141, and the main images 21a, 21b are displayed on the second display screen 142.

According to such Display Method 1, the thumbnail bundle 30 as the first display image is displayed on the first display screen sectioned by the boundary 145, and the main images 21a, 21b as the second display image are displayed on the second display screen 142. Therefore, it is possible to prevent the superimposition between the thumbnail bundle 30 and the main images 21a, 21b, and thus it is possible to prevent viewing of the images from becoming difficult, namely to prevent each of the images from becoming difficult to view when the two images has been superimposed with each other.

It should be noted that as shown in FIG. 3, on the second display screen 142, it is possible to display a reference image 21c in addition to the main images 21a, 21b as the second display image currently displayed. The reference image 21c is determined by selecting a thumbnail image 51c of another page which is desired to be referred to out of the thumbnail bundle 30 currently displayed on the first display screen 141. On this occasion, it is preferable for the reference image 21c to be displayed on the four corners or an end part of the second display screen 142 so as not to hinder the visual recognition of the main images 21a, 21b, but the display position can arbitrarily be set. Further, it is preferable for the reference image 21c to be displayed with a smaller area than those of the main images 21a, 21b, but the display area can arbitrarily be set as needed.

As described above, by displaying the reference image 21c in addition to the main images 21a, 21b on the second display screen 142 constituting the display section 140, it is possible to more accurately perceive the content of the image displayed.

### 1.2.2. Display Example 2

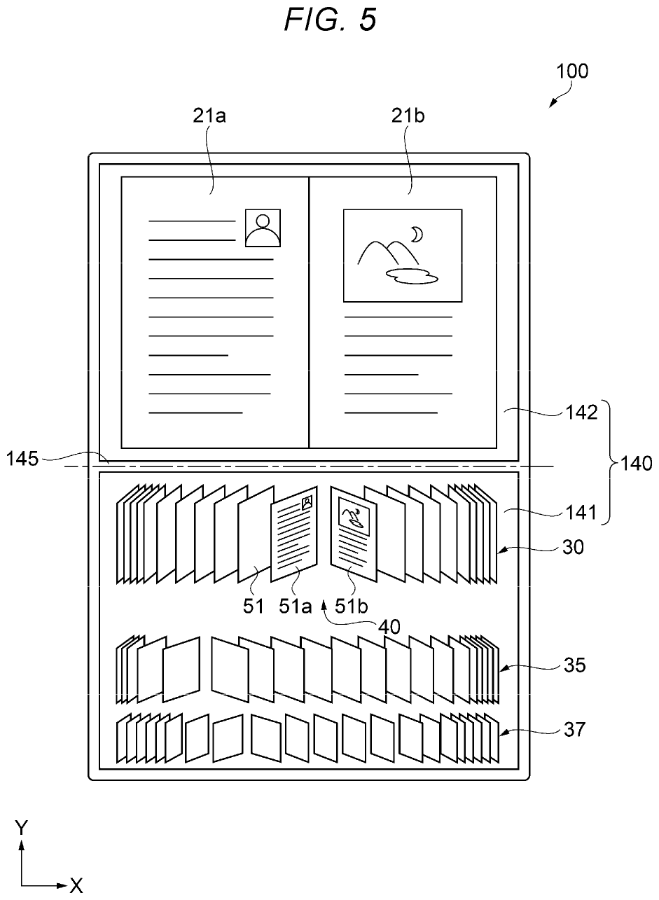

Then, Display Example 2 for performing display using Display Method 1 in the display device 100 will be described with reference to FIG. 5. FIG. 5 is a diagram showing Display Example 2 to be displayed on the display device according to the first embodiment. It should be noted that constituent regions in the display device 100 will be described denoted by the same reference symbols as in the above description.

As shown in FIG. 5, in Display Example 2, the control section 110 displays the thumbnail bundle 30, a second thumbnail bundle 35, and a third thumbnail bundle 37 as the first display image on the first display screen 141 constituting the display section 140. The thumbnail bundle 30 is an image bundle having the thumbnail images 51 of the respective pages included in the selected file arranged in the first direction similarly to Display Example 1, and corresponds to a first thumbnail bundle. Similarly to the thumbnail bundle 30, the second thumbnail bundle 35 and the third thumbnail bundle 37 are each an image bundle having a plurality of thumbnail images arranged in the first direction. In other words, on the first display screen 141, the plurality of image bundles are displayed with an arrangement along the second direction.

In the first display screen 141, the thumbnail bundle 30, the second thumbnail bundle 35, and the third thumbnail bundle 37 are arranged along the second direction. Specifically, the thumbnail bundle 30 is disposed in an area close to the boundary 145 between the first display screen 141 and the second screen 142, and the second thumbnail bundle 35 and the third thumbnail bundle 37 are arranged in this order on the lower side of the thumbnail bundle 30. It should be noted that in the thumbnail bundle 30, the thumbnail images 51a, 51b corresponding to the selected pages selected by the user with the purpose of focusing thereon out of the plurality of thumbnail images 51 included in the thumbnail bundle 30 are displayed as the display 40 in the double-page spread state.

Further, the control section 110 displays the main images 21a, 21b as the second display image on the second display screen 142 constituting the display section 140. Here, the main images 21a, 21b are images displaying, in an enlarged manner, the pages of the thumbnail images 51a, 51b corresponding to the selected pages selected by the user from the plurality of thumbnail images 51 included in the thumbnail bundle 30 displayed on the first display screen 141. In other words, the main images 21a, 21b are enlarged images of the pages which the user wants to focus on out of the pages included in the selected file.

In other words, in Display Example 2, similarly to Display Example 1 described above, the boundary 145 between the first display screen 141 and the second display screen 142 is disposed between the thumbnail bundle 30, the second thumbnail bundle 35, and the third thumbnail bundle 37 as the first display image and the main images 21a, 21b as the second display image adjacent to each other.

It is also possible for each of the thumbnail bundle 30, the second thumbnail bundle 35, and the third thumbnail bundle 37 to have the constituent part in which the thumbnail images 51 adjacent to each other are arranged at regular intervals in a partially superimposed state, and the constituent part in which the thumbnail images 51 adjacent to each other are arranged so that the distance therebetween increases, or a part where the display direction is different is included. Here, since the configuration of the thumbnail images 51 and so on as images constituting the thumbnail bundle 30, the second thumbnail bundle 35, and the third thumbnail bundle 37 is substantially the same as in Display Example 1 described above, the detailed description thereof will be omitted here.

In Display Example 2 described above, the thumbnail bundles each having the plurality of thumbnail images 51 and so on arranged in the first direction, for example, the thumbnail bundle 30, the second thumbnail bundle 35, and the third thumbnail bundle 37, are displayed on the first display screen 141 so as to be arranged along the second direction crossing the first direction. Therefore, according to Display Example 2, in addition to the advantages in Display Example 1, it is possible to display a larger number of thumbnail bundles, thumbnail images 51 and so on in a given display area of the first display screen 141 constituting the display section 140, and it is possible to overview the content of the thumbnail bundle, in other words, the content of the folder constituted by the plurality of thumbnail images 51, or the whole of the content of the file from the plurality of thumbnail images 51 and so on.

### 2. Second Embodiment

### 2.1. Display Device

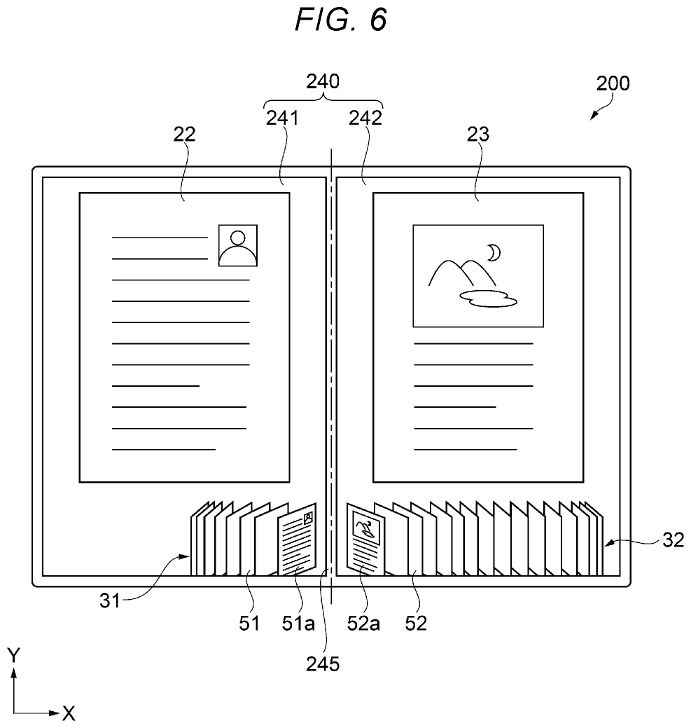

Firstly, a configuration of a display device according to the second embodiment will be described with reference to FIG. 6. FIG. 6 is a diagram showing Display Example 3 of the thumbnail bundle including the thumbnail images and the main page to be displayed on the display device according to the second embodiment.

As shown in FIG. 6, a display device 200 is a device for viewing an electronic book, electrophotography and so on, and displays thumbnail images as images obtained by contracting the pages of the electronic book or the electrophotography as search images of the images of the pages of the electronic book or the electrophotography folded in a file of a folder and a screen desired to be displayed. In other words, the display device 200 is an example of an electronic apparatus capable of displaying an image. Further, in the present embodiment, the description will be presented using a “file” as a collective term of a folder and a file.

Further, in the following description, there are used the “first direction” and the “second direction” similarly to the first embodiment described above. Further, in each of the drawings used for the explanation of the display device 200 and a display section 240, two axes perpendicular to each other are set as an X axis and a Y axis for the sake of convenience of explanation. In other words, the X axis coincides with the “first direction” as a direction along a horizontal direction (a lateral direction) of the display section 240, and the Y axis coincides with the “second direction” as a direction along a vertical direction (a longitudinal direction) of the display section 240. Further, for the sake of convenience of explanation, a positive direction of the Y axis is referred to as “up” or an “upper side,” a negative direction of the Y axis is referred to as “down” or a “lower side,” a positive direction of the X axis is referred to as “right” or a “right side,” and a negative direction of the X axis is referred to as “left” or a “left side” in some cases.

The display device 200 can be constituted by, for example, a smartphone or a tablet-type terminal device. The display device 200 can be coupled to other information processing devices (not shown) with, for example, Near Field Communication or wired communication (not shown), wherein Bluetooth (registered trademark), for example, can be cited as an example of Near Field Communication.

As shown in FIG. 6, the display device 200 according to the second embodiment is provided with the display section 240 having a first display screen 241 and a second display screen 242 as two screens for displaying images. It should be noted that the first display screen 241 corresponds to the first screen, and the second display screen 242 corresponds to the second screen. The first display screen 241 and the second display screen 242 are arranged side by side along the X axis via a boundary 245 constituted by a frame part of the first display screen 241 or the second display screen 242. The display device 200 according to the present embodiment illustrates a folding portable terminal device which can be folded at the boundary 245 part. It is possible for a user to visually recognize an image displayed on the display section 240 having the first display screen 241 and the second display screen 242 formed of a liquid crystal display or the like of the display device 200. It should be noted that it is possible for the display device 200 to use respective screens of two tablet type terminal devices formed as separate individuals, or to use respective screens of two smartphones as the two display screens. Further, it is possible for the display device 200 to combine, for example, the tablet type terminal device and the smartphone with each other to constitute the display section 240. Further, the boundary 245 can be formed of an imaginary line (not shown) for sectioning one screen instead of the frame part.

A hardware configuration of the display device 200 is substantially the same as that of the display device 100 according to the first embodiment shown in FIG. 2 and described above. Therefore, although the description in the present embodiment is omitted, each of the constituent regions will be described using substantially the same names and reference symbols.

As shown in FIG. 6, the control section 110 generates a thumbnail bundle 31 as the image bundle, and a main image 22 for displaying, in an enlarged manner, the thumbnail image 51a of the page selected from the thumbnail images 51 of the respective pages constituting the thumbnail bundle 31 as the first display image. Further, the control section 110 generates a thumbnail bundle 32 as the image bundle, and a main image 23 for displaying, in an enlarged manner, the thumbnail image 52a of the page selected from the thumbnail images 52 of the respective pages constituting the thumbnail bundle 32 as the second display image. Then, the control section 110 displays the first display image on the first display screen 241 as one screen, and displays the second display image on the second display screen 242 as the other screen. In other words, the control section 110 disposes the boundary 245 between the first display screen 241 and the second display screen 242, and displays the first display image and the second display image on the display section 240. Thus, it is possible to prevent the superimposed display between the first display image and the second display image, and it is possible to prevent viewing of the images from becoming difficult, namely to prevent each of the images from becoming difficult to view when the two images has been superimposed with each other.

### 2.2. Display Method 2

### 2.2.1. Display Example 3

Then, Display Example 3 for performing display using Display Method 2 in the display device 200 will hereinafter be described in detail with reference to FIG. 6. It should be noted that constituent regions in the display device 200 will be described denoted by the same reference symbols as in the above description.

As shown in FIG. 6, in Display Example 3, on the first display screen 241 constituting the display section 240, there is displayed the first display image including the thumbnail bundle 31 in which the thumbnail images 51 of the respective pages included in the file selected are arranged in the first direction, and the main image 22 for displaying, in an enlarged manner, the thumbnail image 51a corresponding to the selected page selected from the thumbnail images 51 of the respective pages constituting the thumbnail bundle 31. It should be noted that the first display image is a display image in which the thumbnail bundle 31 is disposed in the vicinity of the lower end of the first display screen 241, and the main image 22 displayed in an enlarged manner is disposed in a broad area on the upper side of the display area of the thumbnail bundle 31.

Further, in Display Example 3, on the second display screen 242 disposed on the opposite side along the X axis to the first display screen 241 about the boundary 245, there is displayed the second display image including the thumbnail bundle 32 in which the thumbnail images 52 of the respective pages included in the file selected are arranged in the first direction, and the main image 23 for displaying, in an enlarged manner, the thumbnail image 52a corresponding to the selected page selected from the thumbnail images 52 of the respective pages constituting the thumbnail bundle 32. It should be noted that the second display image is a display image in which the thumbnail bundle 32 is disposed in the vicinity of the lower end of the second display screen 242, and the main image 23 displayed in an enlarged manner is disposed in a broad area on the upper side of the display area of the thumbnail bundle 32.

Here, the main image 22 in the first display image 22 and the main image 23 in the second display image are images displaying, in an enlarged manner, the thumbnail images 51a, 52a corresponding to the selected pages selected by the user from the pages included in the thumbnail bundles 31, 32, respectively. In other words, the main images 21a, 21b are enlarged images of the pages which the user wants to focus on out of the pages included in the selected file.

In other words, in Display Method 2, the boundary 245 between the first display screen 241 and the second display screen 242 is disposed between the thumbnail bundle 31 and the main image 22 as the first display image and the thumbnail bundle 32 and the main image 23 as the second display image adjacent to each other.

It should be noted that the thumbnail images 51, 52 constituting the thumbnail bundles 31, 32 have the constituent part in which the thumbnail images are arranged at regular intervals in a partially superimposed state, and the constituent part in which the thumbnail images adjacent to each other are arranged so that the distance therebetween increases, or a part where the display direction is different is included, respectively. Here, the thumbnail images 51, 52 of the respective pages are deformed so that there is obtained substantially the same appearance of the pages as when obliquely viewing the plurality of thumbnail images 51, 52 included in the respective thumbnail bundles 31, 32 from obliquely above, and looking down the plurality of thumbnail images 51, 52. The deformation method is substantially the same as in Display Example 1 described above, and therefore, the detailed description thereof will be omitted here.

It should be noted that the main image 22 included in the first display image and the main image 23 included in the second display image are each not limited to what displays one page in an enlarged manner, but it is possible to select two or more pages to be displayed in an enlarged manner.

According to Display Example 3 described above, the first display image including the thumbnail bundle 31 and the main image 22 for displaying, in an enlarged manner, the page selected from the thumbnail bundle 31 is displayed on the first display screen 241 as one screen, and the second display image including the thumbnail bundle 32 and the main image 23 for displaying, in an enlarged manner, the page selected from the thumbnail bundle 32 is displayed on the second display screen 242 as the other screen. In other words, by displaying the boundary 245 between the first display screen 241 and the second display screen 242 so as to be disposed between the first display image and the second display image adjacent to each other, it is possible to prevent the superimposed display between the first display image and the second display image, and it is possible to prevent viewing of the images from becoming difficult, namely to prevent each of the images from becoming difficult to view when the two images has been superimposed with each other.

### 2.2.2. Display Example 4

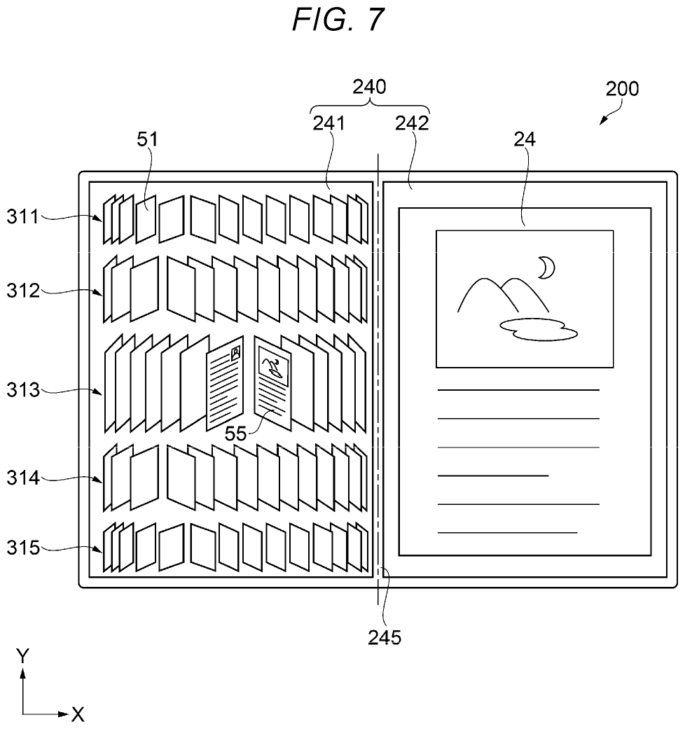

Then, Display Example 4 for performing display using Display Method 2 in the display device 200 will be described with reference to FIG. 7. FIG. 7 is a diagram showing Display Example 4 to be displayed on the display device according to the second embodiment. It should be noted that constituent regions in the display device 200 will be described denoted by the same reference symbols as in the above description.

As shown in FIG. 7, in Display Example 4, a plurality of thumbnail bundles 311, 312, 313, 314, and 315 is displayed on the first display screen 241 constituting the display section 240 so as to be arranged along the Y axis. In each of the thumbnail bundles 311, 312, 313, 314, and 315, the thumbnail images 51 of the respective pages included in the selected file are arranged side by side in the first direction. Specifically, the thumbnail bundle 311 is disposed in an upper area of the first display screen 241, and the thumbnail bundle 312, the thumbnail bundle 313, the thumbnail bundle 314, and the thumbnail bundle 315 are disposed in this order on the lower side of the thumbnail bundle 311. It should be noted that in the central part on the X axis of the thumbnail bundle 313, there is displayed the thumbnail image 55 corresponding to the selected page selected as the page which the user wants to focus on in the double-page spread state together with the adjacent thumbnail image.

Further, on the second display screen 242 disposed on the opposite side along the X axis to the first display screen 241 about the boundary 245, there is displayed the main image 24 for displaying, in an enlarged manner, the thumbnail image 55 corresponding to the selected page selected as the page which the user wants to focus on from the plurality of thumbnail bundles 311, 312, 313, 314, and 315 displayed on the first display screen 241.

In other words, in Display Example 4, the plurality of thumbnail bundles 311, 312, 313, 314, and 315 and the main image displaying, in an enlarged manner, the thumbnail image 55 corresponding to the selected page are displayed so as to be arranged on the right and left sides in the display section 240 via the boundary 245, in other words, so as to be arranged side by side along the X axis.

In Display Example 4 described above, the plurality of thumbnail bundles 311, 312, 313, 314, and 315 is displayed on the first display screen 241 so as to be arranged along the second direction (the Y axis). Therefore, according to Display Example 4, in addition to the advantages in Display Example 3 described above, it is possible to display a larger number of thumbnail bundles 311, 312, 313, 314, and 315 in a given display area of the first display screen 241 constituting the display section 240, and it is possible to overview the content of the thumbnail bundles, in other words, the content of the folder constituted by the plurality of thumbnail images 51 and so on, or the whole of the content of the file from the plurality of thumbnail images 51, 55 and so on.

### 3. Modified Example of Display

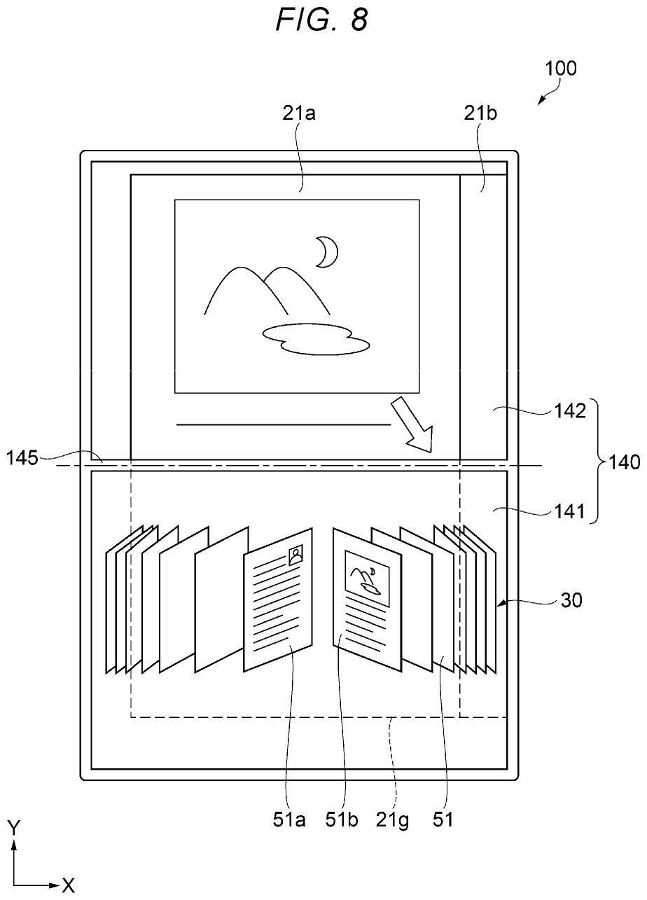

Then, a modified example of display in the display device 100, 200 will be described with reference to FIG. 8. FIG. 8 is a diagram showing the modified example of display. It should be noted that the description will be presented illustrating the display section 140 of the display device 100 in FIG. 8, but substantially the same can also be applied to the display device 200. Further, in the following description, the constituent regions in the display device 100 will be described denoted by the same reference symbols as in the above description.

In the present modified example, the thumbnail bundle 30 in which the thumbnail images 51 of the respective pages included in the selected file are arranged in the first direction is displayed as the first display image on the first display screen 141 constituting the display section 140. It should be noted that in the thumbnail bundle 30, the thumbnail images 51a, 51b corresponding to the selected pages selected as the page which the user wants to focus on from the plurality of thumbnail images 51 included in the thumbnail bundle 30 are displayed in the double-page spread state.

Further, the main images 21a, 21b as the second display image are displayed on the second display screen 142 constituting the display section 140. Here, the main images 21a, 21b are images displaying, in an enlarged manner, the pages of the thumbnail images 51a, 51b corresponding to the selected pages selected by the user from the plurality of thumbnail images 51 included in the thumbnail bundle 30. In other words, the main images 21a, 21b are enlarged images of the pages which the user wants to focus on out of the pages included in the selected file.

In the present modified example, when the first display image or the second display image displayed in such a manner is moved or expanded by an operation such as drag and drop or flick to the screen, the display image of the part running off the first display screen 141 or the second display screen 142 on which the first display image or the second display image are respectively displayed is not displayed. For example, as shown in FIG. 8, even when the main images 21a, 21b as the second display image displayed on the second display screen 142 are expanded in the direction of the arrow in the drawing, and are expanded to the area 21g indicated by the dotted lines in the drawing, the first display screen 141 does not display the display image in the part corresponding to the area 21g indicated by the dotted lines in the drawing, but displays the thumbnail bundle 30 as the first display image. Further, although not shown in the drawing, similarly to the above description, when the thumbnail bundle 30 displayed on the first display screen 141 has been moved or expanded, the second display screen 142 does not display the display image running off the first display screen 141.

According to the display described in the present modified example, it is possible to make each of the first display image and the second display image to be displayed respectively on the first display screen 141 and the second display screen 142 to be an independent image. In other words, there is no chance that an influence of the display state of one display screen is exerted on the other display screen. In the detailed description, for example, when the first display image is displayed on the first display screen 141, and the second display image is displayed on the second display screen 142, even when the first display image is expanded to run off the first display screen 141, the part thus running off of the display image is not displayed on the second display screen 142. Therefore, there is no chance of making an influence on the second display image displayed on the second display screen 142.

It should be noted that the description is presented illustrating the folding portable terminal device as the display device 100, 200 in the embodiments described above, but this is not a limitation. As other display devices, it is possible to apply, for example, a communication terminal device of a smartphone type, a tablet terminal, and a display of a personal computer alone or in combination. Further, as the display device, it is possible to apply a projector which uses, for example, a screen for projecting a picture as the display section, and projects in image configured including the image bundle such as the thumbnail bundle including the images such as the thumbnail images and other images on the screen or the like.

Further, although in Display Example 1, Display Example 2, Display Example 4, and the modified example, the description is presented showing the example of displaying the image bundle on one screen out of the first screen and the second screen, and displaying the main image on the other screen, the combination of the screen and the display image is not limited thereto. It is sufficient for either of the screens to include the image displayed so as to be disposed on the first virtual axis, rotated around the respective second virtual axis crossing the first virtual axis, and further rotated around the first virtual axis. For example, it is also possible to display the main image on one screen, and to display the image bundle on the other screen. Further, it is also possible to display the image bundles on the two screens.

Further, for example, the thumbnail image selected so as to be displayed as the main image is not limited to the display in the double-page spread state described in the embodiments described above, but can also be arranged to be displayed so that the distance between the thumbnail images adjacent to each other is increased to prevent the thumbnail images adjacent to each other from being superimposed with each other. By adopting such display, since the thumbnail images adjacent to each other are displayed so as not to be superimposed with each other, it becomes easy to view the thumbnail image corresponding to the main image in the thumbnail bundle, and thus, it is possible to make it easy to know the content thereof.

Hereinafter, the contents derived from the embodiments described above will be described as the aspects.

### Aspect 1

The display method according to the present aspect is a display method of including an image to be displayed so as to be disposed on a first virtual axis, rotated around a respective second virtual axis crossing the first virtual axis, and further rotated around the first virtual axis in either of a first display image and a second display image, and displaying the first display image and the second display image on a first screen and a second screen, the method including the step of disposing a boundary between the first screen and the second screen between the first display image and the second display image adjacent to each other.

According to the display method related to the present aspect, by displaying the first display image and the second display image respectively on the first screen and the second screen, for example, disposing the first display image on the first screen and the second display image on the second screen, it is possible to prevent the superimposed display between the first display image and the second display image. Therefore, it is possible to prevent viewing of the images from becoming difficult, namely to prevent each of the images from becoming difficult to view when the two images has been superimposed with each other.

### Aspect 2

In the display method described in the above aspect, the first display image and the second display image may be displayed except a part running off one of the first screen and the second screen where the first display image and the second display image are displayed.

According to this aspect, it is possible to make each of the first display image and the second display image to be displayed respectively on the first screen and the second screen to be an independent image. In other words, there is no chance that an influence of the display state of one screen is exerted on the other screen. In the further detailed description, for example, when the first display image is displayed on the first screen, and the second display image is displayed on the second screen, even when the first display image runs off the first screen, the image corresponding to the part thus running off is not displayed on the second screen. Therefore, there is no chance of making an influence on the second display image on the second screen.

### Aspect 3

In the display method described in the above aspect, the first display image may include an image bundle having a plurality of the images arranged in a first direction, and the second display image may include a main image obtained by expanding a page corresponding to an image selected from the plurality of images.

According to the present aspect, since the image bundle having the plurality of images arranged in the first direction is displayed on one screen as the first display image, and the main image obtained by expanding the page corresponding to the image selected from the plurality of images is displayed on the other screen as the second display image, it is possible to make the content of the whole of the image bundle and the content of the image which is wanted to be focused on easier to make out with the two screens, namely the first screen and the second screen.

### Aspect 4

In the display method described in the above aspect, the second display image may include a reference image in addition to the main image, and the reference image may be determined by selecting another image from the image bundle.

According to the present aspect, by displaying the main image and the reference image as the second display image, it is possible to more accurately perceive the content of the display image displayed as the second display image.

### Aspect 5

In the display method described in the above aspect, the image selected may be displayed in a double-page spread state.

According to the present aspect, since the image in the image bundle corresponding to the main image is in the double-page spread state different from the state of other images, it is possible to make it easy to visually recognize the image corresponding to the main image out of the image bundle, and it is possible to make it easy to visually recognize the display contents of the image in the double-page spread state and other images adjacent thereto.

### Aspect 6

In the display method described in the above aspect, the image selected may be displayed so as to increase in distance from an adjacent image to prevent superimposition with the adjacent image.

According to the present aspect, since the image in the image bundle corresponding to the main image is displayed so as to increase in distance from the adjacent image to prevent the image adjacent to each other from being superimposed with each other, it becomes easy to view the image corresponding to the main image in the image bundle, and is possible to make it easy to know the content thereof.

### Aspect 7

In the display method described in the above aspect, a plurality of the image bundles may be displayed so as to be arranged in a second direction crossing the first direction.

According to the present aspect, the plurality of image bundles each having a plurality of images arranged in the first direction is displayed so as to be arranged along the second direction crossing the first direction. Therefore, it is possible to display a larger number of image bundles and the images included in the image bundles in a given display area of the display section, and it is possible to overview the content of the image bundles, in other words, the content of the folder constituted by the plurality of images, or the whole of the content of the file consisting of the plurality of images.

### Aspect 8

The display device according to the present aspect includes a first screen and a second screen on which either of a first display image and a second display image is displayed, an image generation section configured to generate an image displayed so as to be disposed on a first virtual axis, rotated around a second virtual axis crossing the first virtual axis, and further rotated around the first virtual axis, a display image generation section configured to generate the first display image and the second display image so that the image is included in either of the first display image and the second display image, and a control section configured to display the first display image and the second display image on the first screen and the second screen so that a boundary between the first screen and the second screen is disposed between the first display image and the second display image adjacent to each other.

According to the display device related to the present aspect, since the first screen and the second screen on which either of the first display image and the second display image is displayed are provided, and the boundary between the first screen and the second screen is disposed between the first display image and the second display image adjacent to each other, it is possible to respectively display the first display image and the second display image on the first screen and the second screen, for example, to display the first display image on the first screen and display the second display image on the second screen. Thus, it is possible to prevent the superimposed display between the first display image and the second display image, and it is possible to prevent viewing of the images from becoming difficult, namely to prevent each of the images from becoming difficult to view when the two images has been superimposed with each other.

What is claimed is:

1. A display method of including an image to be displayed so as to be disposed on a first virtual axis, rotated around a respective second virtual axis crossing the first virtual axis, and further rotated around the first virtual axis in either of a first display image and a second display image, and displaying the first display image and the second display image on a first screen and a second screen, the method comprising:
disposing a boundary between the first screen and the second screen between the first display image and the second display image adjacent to each other.

2. The display method according to claim 1, wherein
the first display image and the second display image are displayed except a part running off one of the first screen and the second screen where the first display image and the second display image are displayed.

3. The display method according to claim 1, wherein
the first display image includes an image bundle having a plurality of the images arranged in a first direction, and
the second display image includes a main image obtained by expanding a page corresponding to an image selected from the plurality of images.

4. The display method according to claim 3, wherein
the second display image includes a reference image in addition to the main image, and
the reference image is determined by selecting another image from the image bundle.

5. The display method according to claim 3, wherein
the image selected is displayed in a double-page spread state.

6. The display method according to claim 3, wherein
the image selected is displayed so as to increase in distance from an adjacent image to prevent superimposition with the adjacent image.

7. The display method according to claim 3, wherein
a plurality of the image bundles is displayed so as to be arranged in a second direction crossing the first direction.

8. A display device comprising:
a first screen and a second screen on which either of a first display image and a second display image is displayed;
an image generation section configured to generate an image displayed so as to be disposed on a first virtual axis, rotated around a second virtual axis crossing the first virtual axis, and further rotated around the first virtual axis;
a display image generation section configured to generate the first display image and the second display image so that the image is included in either of the first display image and the second display image; and
a control section configured to display the first display image and the second display image on the first screen and the second screen so that a boundary between the first screen and the second screen is disposed between the first display image and the second display image adjacent to each other.
